(19) United States
(12) Patent Application Publication
(10) Pub. No.: US 2026/0371245 A1
(43) Pub. Date: Nov. 19, 2026

(54) LOWER POWER WAKE-UP SIGNAL OPERATION WITH DISCONTINUOUS RECEPTION CONFIGURATION

(71) Applicant: Nokia Technologies Oy, Espoo (FI)

(72) Inventors: Chunli WU, Beijing (CN); Samuli Heikki TURTINEN, Oulu (FI); Jussi-Pekka KOSKINEN, Oulu (FI); Jorma Johannes KAIKKONEN, Oulu (FI)

(21) Appl. No.: 19/121,004

(22) PCT Filed: Nov. 7, 2022
(86) PCT No.: PCT/CN2022/130440

§ 371 Date: Apr. 14, 2025

(51) Int. Cl. H04W 52/02; H04W 72/23; H04W 76/28

(52) U.S. Cl. CPC H04W 52/0235; H04W 72/23; H04W 76/28

(57) ABSTRACT

Example embodiments of the present disclosure relate to low power wake-up signal (LP-WUS) operation with discontinuous reception (DRX) configuration. In an example method, an apparatus obtains, from a network device, a discontinuous reception (DRX) configuration for the apparatus. The apparatus monitors a low power wake-up signal (LP-WUS) from the network device during a time period, wherein at least one of an OnDuration timer or an inactivity timer of the DRX configuration is started based on a time point of reception of the LP-WUS during the time period. In this way, a mechanism for LP-WUS with DRX configured may be defined. WO

### FIELD

Example embodiments of the present disclosure generally relate to the field of telecommunication, and in particular, to apparatuses, methods and a computer-readable storage medium for low power wake-up signal (LP-WUS) operation with discontinuous reception (DRX) configuration.

### BACKGROUND

5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Design to prolong battery life is a necessity for improving energy efficiency as well as for better user experience.

### SUMMARY

In general, example embodiments of the present disclosure provide a solution for LP-WUS operation with DRX configuration.

In a first aspect, there is provided an apparatus. The apparatus comprises: at least one processor; and at least one memory storing instructions that, when executed by the at least one processor, cause the apparatus at least to: obtain, from a network device, a discontinuous reception (DRX) configuration for the apparatus; and monitor a low power wake-up signal (LP-WUS) from the network device during a time period, wherein at least one of an OnDuration timer or an inactivity timer of the DRX configuration is started based on a time point of reception of the LP-WUS during the time period.

In a second aspect, there is provided an apparatus. The apparatus comprises: at least one processor; and at least one memory storing instructions that, when executed by the at least one processor, cause the network device at least to: transmit, to a terminal device, a discontinuous reception (DRX) configuration for the terminal device; and transmit, to the terminal device, first information indicating a time period, the first information configuring the terminal device to monitor a low power wake-up signal (LP-WUS) from the apparatus during the time period, wherein at least one of an OnDuration timer or an inactivity timer of the DRX configuration is started based on a time point of reception of the LP-WUS by the terminal device during the time period.

In a third aspect, there is provided a method performed by a terminal device. The method comprises: obtaining, at the terminal device and from a network device, a discontinuous reception (DRX) configuration for the terminal device; and monitoring, by the terminal device, a low power wake-up signal (LP-WUS) from the network device during a time period, wherein at least one of an OnDuration timer or an inactivity timer of the DRX configuration is started based on a time point of reception of the LP-WUS during the time period.

In a fourth aspect, there is provided a method performed by a network device. The method comprises: transmitting, by the network device and to a terminal device, a discontinuous reception (DRX) configuration for the terminal device; and transmitting, by the network device and to the terminal device, first information indicating a time period, the first information configuring the terminal device to monitor a low power wake-up signal (LP-WUS) from the network device during the time period, wherein at least one of an OnDuration timer or an inactivity timer of the DRX configuration is started based on a time point of reception of the LP-WUS by the terminal device during the time period.

In a fifth aspect, there is provided an apparatus. The apparatus comprises: means for obtaining, from a network device, a discontinuous reception (DRX) configuration for the apparatus; and means for monitoring a low power wake-up signal (LP-WUS) from the network device during a time period, wherein at least one of an OnDuration timer or an inactivity timer of the DRX configuration is started based on a time point of reception of the LP-WUS during the time period.

In a sixth aspect, there is provided an apparatus. The apparatus comprises: means for transmitting, to a terminal device, a discontinuous reception (DRX) configuration for the terminal device; and means for transmitting, to the terminal device, first information indicating a time period, the first information configuring the terminal device to monitor a low power wake-up signal (LP-WUS) from the network device during the time period, wherein at least one of an OnDuration timer or an inactivity timer of the DRX configuration is started based on a time point of reception of the LP-WUS by the terminal device during the time period.

In a seventh aspect, there is provided a non-transitory computer-readable storage medium comprising instructions. The instructions, when executed by an apparatus, cause the apparatus to perform at least the following: obtaining, from a network device, a discontinuous reception (DRX) configuration for the apparatus; and monitoring a low power wake-up signal (LP-WUS) from the network device during a time period, wherein at least one of an OnDuration timer or an inactivity timer of the DRX configuration is started based on a time point of reception of the LP-WUS during the time period.

In an eighth aspect, there is provided a non-transitory computer-readable storage medium comprising instructions. The instructions, when executed by an apparatus, cause the apparatus to perform at least the following: transmitting, to a terminal device, a discontinuous reception (DRX) configuration for the terminal device; and transmitting, to the terminal device, first information indicating a time period associated with an On-duration of the DRX configuration, the first information configuring the terminal device to monitor a low power wake-up signal (LP-WUS) from the apparatus during the time period, wherein at least one of an OnDuration timer or an inactivity timer of the DRX configuration is started based on a time point of reception of the LP-WUS by the terminal device during the time period.

In a ninth aspect, there is provided a computer program comprising instructions, which, when executed by an apparatus, cause the apparatus at least to: obtain, from a network device, a discontinuous reception (DRX) configuration for the apparatus; and monitor a low power wake-up signal (LP-WUS) from the network device during a time period, wherein at least one of an OnDuration timer or an inactivity timer of the DRX configuration is started based on a time point of reception of the LP-WUS during the time period.

In a tenth aspect, there is provided a computer program comprising instructions, which, when executed by an apparatus, cause the apparatus at least to: transmit, to a terminal device, a discontinuous reception (DRX) configuration for the terminal device; and transmit, to the terminal device, first information indicating a time period, the first information configuring the terminal device to monitor a low power wake-up signal (LP-WUS) from the apparatus during the time period, wherein at least one of an OnDuration timer or an inactivity timer of the DRX configuration is started based on a time point of reception of the LP-WUS by the terminal device during the time period.

In an eleventh aspect, there is provided an apparatus. The apparatus comprises: obtaining circuitry configured to obtain, from a network device, a discontinuous reception (DRX) configuration for the apparatus; and monitoring circuitry configured to monitor a low power wake-up signal (LP-WUS) from the network device during a time period, wherein at least one of an OnDuration timer or an inactivity timer of the DRX configuration is started based on a time point of reception of the LP-WUS during the time period.

In a twelfth aspect, there is provided an apparatus. The apparatus comprises: transmitting circuitry configured to transmit, to a terminal device, a discontinuous reception (DRX) configuration for the terminal device; and transmitting circuitry configured to transmit, to the terminal device, first information indicating a time period, the first information configuring the terminal device to monitor a low power wake-up signal (LP-WUS) from the apparatus during the time period, wherein at least one of an OnDuration timer or an inactivity timer of the DRX configuration is started based on a time point of reception of the LP-WUS by the terminal device during the time period.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates a schematic diagram of UE operations with low-power wake-up receiver (WUR) based on which some example embodiments of the present disclosure may be implemented;

FIG. 2 illustrates a flowchart illustrating a communication process in accordance with some example embodiments of the present disclosure;

FIG. 3 illustrates a flowchart of an example method implemented at a first device in accordance with some embodiments of the present disclosure;

FIG. 4 illustrates another flowchart of an example method implemented at a second device in accordance with some embodiments of the present disclosure; and

FIG. 5 illustrates a simplified block diagram of a device that is suitable for implementing some example embodiments of the present disclosure; and

FIG. 6 illustrates a block diagram of an example of a computer-readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. In the following description, the terms “network device” and “network node” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Energy efficiency is even more critical for UE without a continuous energy source, e.g., UE using small rechargeable and single coin cell batteries. The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency. A UE architecture is proposed by using a wake-up signal to trigger the main radio and a separate receiver which has the ability to monitor wake-up signal with ultra-low power consumption. Main radio works for data transmission and reception, which can be turned off or set to deep sleep unless it is turned on. The power consumption for monitoring wake-up signal depends on the wake-up signal design and the hardware module of the wake-up receiver used for signal detecting and processing.

The present disclosure primarily targets to low-power WUS/WUR for power-sensitive, small form-factor devices including IoT use cases (such as industrial sensors, controllers) and wearables. Other use cases are not precluded, e.g., XR/smart glasses, smart phones. The present disclosure considers the usage of a separate low-power wake-up receiver at the UE, and evaluates how that can reduce the UE power consumption. The intention is that the main radio of the UE can be in a sleep mode (or even powered off) for power saving and be activated only upon the reception of the wake-up signal from the network. Basically, the network triggers the UE to wake-up exactly when needed in an event-driven manner, by transmitting a special WUS to the UE, which is monitored by the dedicated LP WUS receiver at the UE. When a UE receives the WUS, the WUS receiver can trigger the wake-up of the ordinary NR transceiver and communication can start. Thus, the ultra-low power receiver wakes up the main radio and otherwise, the main radio is OFF or kept in a deep sleep mode. The assumption is that the low-power wake-up receiver can be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

Current discussions mainly focused on DL reception where LP-WUS can be used to wake up the main radio to receive PDCCH/PDSCH. It is unclear how the UE switches back to LP-WUS mode. It is also unclear yet whether LP-WUS works on top of DRX or also works without DRX configuration. When DRX is configured, the UE monitors PDCCH during active time. It is not clear whether and how LP-WUS is monitored during the active time. Thus, it needs to be discussed the LP-WUS works under DRX configuration.

Example embodiments of this disclosure relates to how the LP-WUS works together with DRX. Example embodiments of the present disclosure provide a mechanism to solve the above discussed issues. In some example embodiments of the present disclosure, on OnDuration/inactivity timer handling when the UE is in LP-WUS mode (i.e. monitoring LP-WUS only), LP-WUS may be monitored during a configured period which can dynamically start OnDuration/inactivity timer at any point within the configured period. In this way, an operation mechanism for LP-WUS with DRX configured may be defined.

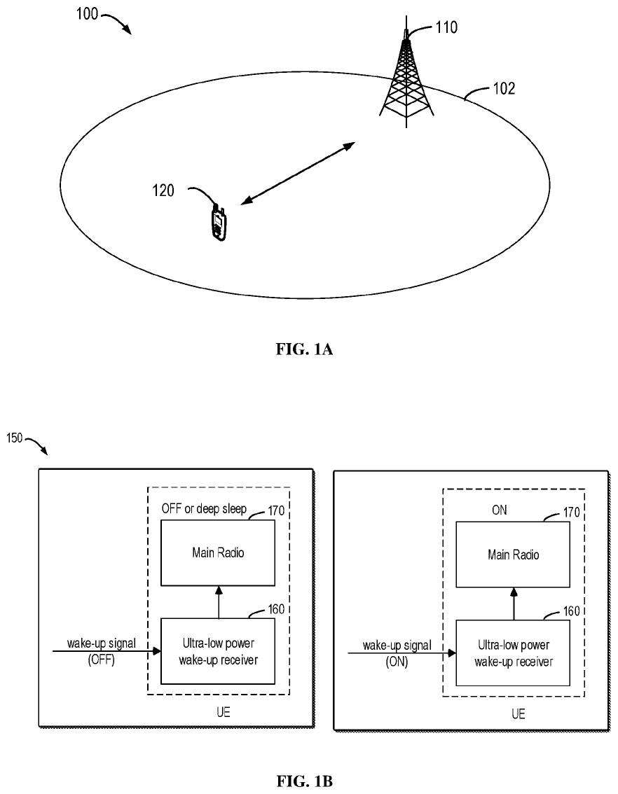

FIG. 1A illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices that communicate with one another. It should be appreciated, however, that the description herein may be applicable to other types of apparatus or other similar apparatuses that are referenced using other terminology.

The network device 110 can provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some embodiments, the network device 110 can provide multiple serving cells. It is to be understood that the number of serving cell(s) shown in FIG. 1A is for illustrative purposes only without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes only without suggesting any limitation. The communication system 100 may comprise any suitable number of devices adapted for implementing embodiments of the present disclosure.

As described above, 5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life are necessary for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in 3GPP TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, extended discontinuous reception (eDRX) cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

Currently, UEs need to periodically wake up once per DRX cycle, which dominates the power consumption in periods with no signaling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on. This will be described in more detail with reference to FIG. 1B.

FIG. 1B illustrates a schematic diagram of operations of UE 150 with low-power wake-up receiver (WUR) based on which some example embodiments of the present disclosure may be implemented. Such a UE 150 primarily targets low-power WUS/WUR for power-sensitive, small form-factor devices including IoT use cases (such as industrial sensors, controllers) and wearables. Other use cases are not precluded, e.g., XR/smart glasses, smart phones. As illustrated in FIG. 1B, the UE 150 includes a main radio 170 and a separate receiver, i.e., an ultra-low power wake-up receiver 160.

The main radio 170 of the UE 150 can be in a sleep mode (or even powered off) for power saving and be activated only upon the reception of the wake-up signal from the network (e.g., from a network device). Basically, the network triggers the UE 150 to wake-up exactly when needed in an event-driven manner, by transmitting a special WUS to the UE 150, which is monitored by the dedicated low-power WUS receiver 160 at the UE 150. When the UE 150 receives the WUS, the WUS receiver 160 can trigger the wake-up of the ordinary NR transceiver (which is included in the main radio 170) and communication can start. Thus, the ultra-low power wake-up receiver 160 wakes up the main radio 170 and otherwise, the main radio 170 is OFF or kept in a deep sleep mode, as shown in FIG. 1B.

Strictly speaking, the power consumption for monitoring wake-up signal depends on the wake-up signal design and the hardware module of the wake-up receiver used for signal detecting and processing. Whereas, the assumption is that the low-power wake-up receiver 160 can be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

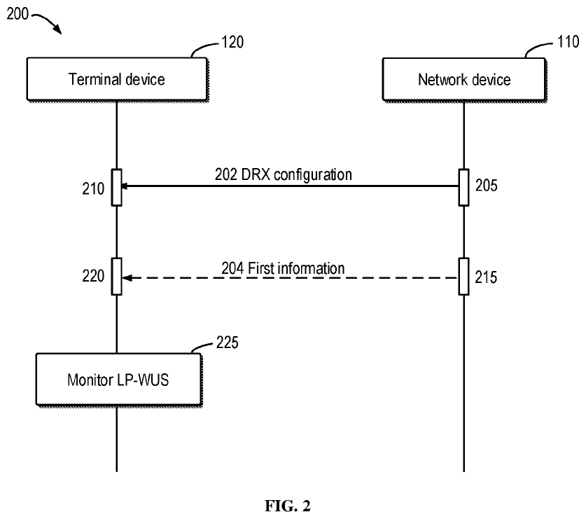

FIG. 2 illustrates a flowchart illustrating a communication process 200 in accordance with some example embodiments of the present disclosure. For the purpose of discussion, the communication process 200 will be described with reference to FIGS. 1A-1B. It would be appreciated that although the communication process 200 has been described referring to the network environment 100 of FIG. 1A, this communication process 200 may be likewise applied to other similar communication scenarios.

In the communication process 200, the network device 110 transmits (205), to the terminal device 120, a DRX configuration 202 for the terminal device 120. Accordingly, the terminal device 120 may receive (210) the DRX configuration 202. In some embodiments, the DRX configuration 202 may comprise DRX configuration parameters, for example, but not limited to, drx-onDuration Timer, drx-InactivityTimer, drx-ShortCycleTimer, longDRX-CycleStartOffset, drx-SlotOffset, drx-RetransmissionTimerDL, drx-RetransmissionTimerUL, drx-ShortCycle, drx-HARQ-RTT-TimerDL, drx-HARQ-RTT-TimerUL, etc. In explicit signaling based DRX adaption, the terminal device 120 is assumed to have a DRX configuration that is adapted by explicit signaling transmitted by the network device 110. The explicit signaling transmitted by the network device 110 to adapt the DRX configuration may performed by the RRC (e.g. RRC message), MAC (e.g. MAC CE) or PHY (e.g. DCI).

In some embodiments, the network device 110 may transmit (215), to the terminal device 120, first information 204 indicating a time period. Accordingly, the terminal device 120 may receive (220) the DRX configuration 204. The first information 204 may configure the terminal device 120 to monitor a LP-WUS from the network device 110 during the time period. In some embodiments, an OnDuration timer of the DRX configuration may be started based on a time point of reception of the LP-WUS by the terminal device 120 during the time period. Alternatively or additionally, an inactivity timer of the DRX configuration may be started based on a time point of reception of the LP-WUS by the terminal device 120 during the time period. The OnDuration timer and the inactivity timer may be indicated by parameters drx-onDurationTimer and drx-InactivityTimer in the DRX configuration 202, respectively. In alternative embodiments, the terminal device 120 may be preconfigured or implicitly indicated with the time period to monitor a LP-WUS from the network device 110 during the time period.

The terminal device 120 monitors (225) a LP-WUS from the network device 110 during the time period. For example, the terminal device 120 may perform the LP-WUS monitoring during the time period based on the first information 204 or pre-configuration or implicit indication. In some embodiments, an OnDuration timer of the DRX configuration may be started based on a time point of reception of the LP-WUS during the time period. Alternatively or additionally, an inactivity timer of the DRX configuration may be started based on a time point of reception of the LP-WUS during the time period. In alternative embodiments, no timer may be started but the LP-WUS may be only monitored at the time period. In this way, the mechanism of monitoring LP-WUS under DRX configuration may be defined.

In some embodiments, the time period may be associated with an On-duration of the DRX configuration. For example, the On-duration of the DRX configuration may be based on the time while drx-onDurationTimer is running. Alternatively, there might be no on-Duration at all, e.g., in situations where an inactivity timer may be directly started.

In some embodiments, the OnDuration timer may be started or restarted at a time point based on receiving the LP-WUS from the network device 110. For example, upon receiving the LP-WUS from the network device 110, a main radio in the terminal device 120 may be turned on to monitor PDCCH from the network device 110 before the OnDuration timer expires. When the OnDuration timer expires, the main radio in the terminal device 120 may be turned off or set to deep sleep. In some embodiments, the time point may be within the time period. Alternatively, there might be a delay after the LP-WUS reception and the start of OnDuration timer might not fall into the period for LP-WUS monitoring.

In some embodiments, upon reception of the LP-WUS waking up for monitoring a PDCCH from the network device 110, the OnDuration timer may run only for a remaining time period of the OnDuration after reception of the LP-WUS from the network device 110. For example, the period for LP-WUS monitoring may be considered as part of OnDuration. In an instance, the OnDuration may be a time period from t1 to t3, the terminal device 120 may receive the LP-WUS from the network device 110 at instant t2 between t1 to t3. Accordingly, the main radio in the terminal device 120 may be turned on to monitor PDCCH from the network device 110 during the time period from t2 to t3. At the end of the OnDuration, i.e., at instant t3, the OnDuration timer may expire and the main radio in the terminal device 120 may be turned off or set to deep sleep.

In some embodiments, the OnDuration timer may run for a period of an OnDuration value regardless of at which time point the LP-WUS is received. For example, the period for LP-WUS monitoring may be not considered as part of OnDuration. The starting point of the OnDuration timer may be dynamically triggers by the received LP-WUS and the OnDuration timer may run for the period of the OnDuration value regardless of at which point the LP-WUS is received. In an instance, the OnDuration may be a time period from t1 to t3=t1+Δt1, the terminal device 120 may receive the LP-WUS from the network device 110 at instant t2 between t1 to t3. The OnDuration timer may start at the instant t2 and expire at the instant t4=t2+Δt2, Δt2 may equal to or may not equal to Δt1. Accordingly, the main radio in the terminal device 120 may be turned on to monitor PDCCH from the network device 110 during the time period from t2 to t4. The main radio in the terminal device 120 may be turned off or set to deep sleep when the OnDuration timer expires at the instant t4.

In some embodiments, the LP-WUS may be not configured or may be not monitored outside of the OnDuration. For example, both the main radio and the LP-WUS receiver of the terminal device 120 may be turned off or set to deep sleep during the “OFF time” of the OnDuration patterns.

In some embodiments, the time period may be the On-duration of the DRX configuration. For example, the OnDuration may be mainly used for the period for LP-WUS decoding. In an instance, the LP-WUS receiver of the terminal device 120 may be turned on during the OnDuration. In some embodiments, the terminal device 120 may start the inactivity timer upon reception of the LP-WUS. In an instance, once the LP-WUS is received during the OnDuration, the inactivity timer may be started and the main radio of the terminal device 120 may monitor PDCCH before the inactivity timer expires.

In some embodiments, upon reception of the LP-WUS, the terminal device 120 may wake up to monitor the PDCCH until receiving an UL grant or DL assignment from the network device 110 and start the inactivity timer based on receiving the UL grant or the DL assignment. For example, once the LP-WUS is received, the main radio of the terminal device 120 may start to monitor PDCCH. The inactivity timer may be started once the main radio receives a first PDCCH and the main radio may keep monitoring the PDCCH before the inactivity timer expires.

According to the above embodiments, the terminal device 120 may be configured to monitor the LP-WUS and may be switched to monitoring the PDCCH once receiving the LP-WUS. When switched to monitoring the PDCCH, the terminal device 120 may determine whether to continue monitoring the PDCCH in normal DRX configuration, or to switch back to monitoring LP-WUS in various manners.

In some embodiments, the terminal device 120 may switch from monitoring the PDCCH to monitoring the LP-WUS when a timer associated with the monitoring of the PDCCH expires. For example, the terminal device 120 may operate with in normal DRX configuration for a period of time (which may be more than one DRX cycle) before a timer expires. In other words, when switched to monitoring the PDCCH, the terminal device 120 may continue monitoring the PDCCH in normal DRX configuration for a period of time, during which the main radio of the terminal device 120 may be turned on and off as in normal DRX configuration. There is no need to send LP-WUS to wake up PDCCH monitoring for each OnDuration when the terminal device 120 is monitoring the PDCCH or when the timer is running. The timer for switching back to monitoring LP-WUS may be implemented in various manners, e.g., similar to Short DRX cycle timer.

In some embodiments, the timer for switching back to monitoring LP-WUS may be started after the terminal device 120 starts to use a long DRX cycle. In other words, when switched to monitoring the PDCCH, the terminal device 120 may continue monitoring the PDCCH in normal DRX configuration. When a long DRX cycle is started, the terminal device 120 may start the timer for switching back to monitoring LP-WUS.

In alternative embodiments, the timer may be started or restarted after a PDCCH reception. Alternatively or additionally, the timer may be started or restarted after an uplink transmission. For example, whenever the terminal device 120 performs a PDCCH reception or an uplink transmission, the timer may be started or restarted. In this way, if the timer expires, it means that no UL/DL transmission occurs during the time period that the timer runs, and the terminal device 120 may then switch to monitoring the LP-WUS. The value of the timer may be configured by the network device 110. Alternatively, the value of the timer may be a default value.

In some embodiments, the terminal device 120 may switch to monitoring the LP-WUS based on determining that a long DRX is to be started or receiving a long DRX command media access control (MAC) control element (CE) from the network device 110. For example, the timer or command for starting the long DRX cycle may be reused to starts the LP-WUS mode. In other words, the terminal device 120 would not experience long DRX cycles and may switch back to monitoring the LP-WUS before the long DRX cycle starts.

In some embodiments, the LP-WUS may be associated to each OnDuration for each DRX cycle of the DRX configuration. In other words, the LP-WUS is always needed to trigger PDCCH monitoring in each OnDuration of each DRX cycle. In some embodiments, the terminal device 120 may monitor the LP-WUS during each OnDuration of each DRX cycle. If the terminal device 120 did not receive LP-WUS during an OnDuration, the terminal device 120 would not monitor the PDCCH.

In some embodiments, the terminal device 120 may switch from monitoring the PDCCH to monitoring the LP-WUS based on determining that an active time ends. In other words, after the active time ends, the terminal device 120 may automatically fall back to LP-WUS mode. In the next cycle, if PDCCH transmission is needed, the network device 110 would need to send another LP-WUS to wake up PDCCH monitoring on the main radio of the terminal device 120.

In some embodiments, the network device 110 may provide LP-WUS configuration to the terminal device 120. The LP-WUS configuration may include time period associated with an On-duration of the DRX configuration and other needed information for LP-WUS e.g. when the UE shall monitor LP-WUS i.e. LP-WUS monitoring occasions. For example, the terminal device 120 may receive the first information 204 indicating the time period from the network device 110. Alternatively or additionally, the terminal device 120 may receive, from the network device 110, second information on a timer associated with the monitoring of the PDCCH. Alternatively or additionally, the terminal device 120 may receive, from the network device 110, third information configuring the terminal device 120 to switch to monitoring the LP-WUS when a long DRX is to be started or receiving a long DRX command MAC CE from the network device 110. Alternatively or additionally, the terminal device 120 may receive, from the network device 110, fourth information configuring the terminal device 120 to switch from monitoring the PDCCH to monitoring the LP-WUS when an active time ends. The terminal device 120 may monitor LP-WUS based on the received information.

Through the process flow 200, a mechanism for LP-WUS with DRX configured may be defined.

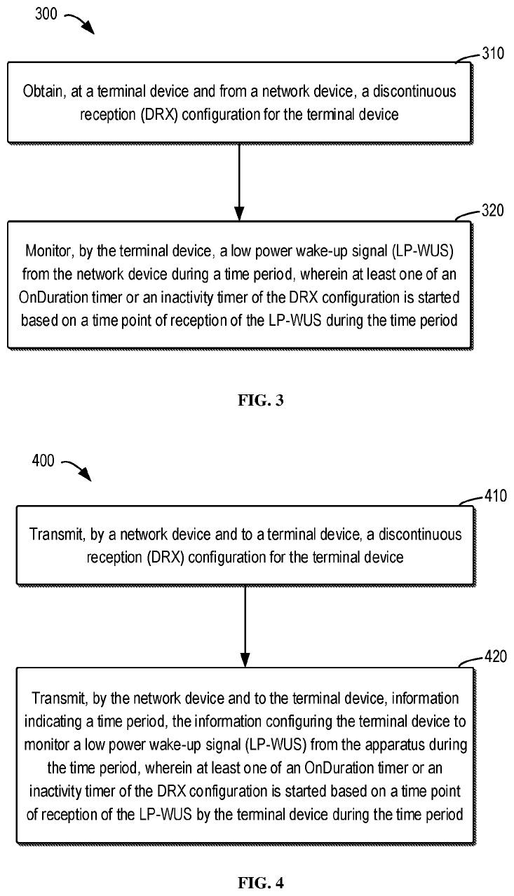

FIG. 3 illustrates a flowchart of an example method 300 implemented at a terminal device 120 in accordance with some other embodiments of the present disclosure. For the purpose of discussion, the method 300 will be described from the perspective of the terminal device 120 with reference to FIGS. 1A-2.

At block 310, the terminal device 120 obtains, from a network device 110, a DRX configuration for the terminal device 120. At block 320, the terminal device 120 monitors a LP-WUS from the network device 110 during a time period. In some embodiments, An OnDuration timer of the DRX configuration is started based on a time point of reception of the LP-WUS during the time period. Alternatively or additionally, an inactivity timer of the DRX configuration is started based on a time point of reception of the LP-WUS during the time period.

In some embodiments, the OnDuration timer may be started or restarted at a time point based on receiving the LP-WUS from the network device 110. In some embodiments, upon reception of the LP-WUS waking up for monitoring a physical downlink control channel (PDCCH) from a network device 110, the OnDuration timer may run only for a remaining time period of the OnDuration after reception of the LP-WUS from the network device 110. In some embodiments, the OnDuration timer may run for a period of an OnDuration value regardless of at which time point the LP-WUS is received.

In some embodiments, the LP-WUS may be not configured or may be not monitored outside of the OnDuration. In some embodiments, the time period may be the On-duration of the DRX configuration. In some embodiments, the terminal device 120 may start the inactivity timer upon reception of the LP-WUS.

In some embodiments, upon reception of the LP-WUS, the terminal device 120 may wake up to monitor the PDCCH until receiving an UL grant or DL assignment from the network device 110. Based on receiving the UL grant or the DL assignment, the terminal device 120 may start the inactivity timer.

In some embodiments, the terminal device 120 may switch from monitoring the PDCCH to monitoring the LP-WUS when a timer associated with the monitoring of the PDCCH expires. In some embodiments, the timer may be started after the terminal device 120 starts to use a long DRX cycle. In some embodiments, the timer may be started or restarted after a PDCCH reception. Alternatively or additionally, the timer may be started or restarted after an uplink transmission.

In some embodiments, the terminal device 120 may switch to monitoring the LP-WUS based on determining that a long DRX is to be started or receiving a long DRX command media access control (MAC) control element (CE) from the network device 110. In some embodiments, the LP-WUS may be associated to each OnDuration for each DRX cycle of the DRX configuration. In some embodiments, the terminal device 120 may switch from monitoring the PDCCH to monitoring the LP-WUS based on determining that an active time ends.

In some embodiments, the terminal device 120 may receive the first information 204 indicating the time period from the network device 110. Alternatively or additionally, the terminal device 120 may receive, from the network device 110, second information on a timer associated with the monitoring of the PDCCH. Alternatively or additionally, the terminal device 120 may receive, from the network device 110, third information configuring the terminal device 120 to switch to monitoring the LP-WUS when a long DRX is to be started or receiving a long DRX command MAC CE from the network device 110. Alternatively or additionally, the terminal device 120 may receive, from the network device 110, fourth information configuring the terminal device 120 to switch from monitoring the PDCCH to monitoring the LP-WUS when an active time ends.

FIG. 4 illustrates another flowchart of an example method 400 implemented at a network device 110 in accordance with some other embodiments of the present disclosure. For the purpose of discussion, the method 400 will be described from the perspective of the network device 110 with reference to FIGS. 1A-2.

At block 410, the network device 110 transmits, to a terminal device 120, a DRX configuration for the terminal device 120. At block 420, the network device 110 transmits, to the terminal device 120, first information indicating a time period. The first information configures the terminal device 120 to monitor a LP-WUS from the network device 110 during the time period. In some embodiments, an OnDuration timer of the DRX configuration is started based on a time point of reception of the LP-WUS by the terminal device 120 during the time period. Alternatively or additionally, an inactivity timer of the DRX configuration is started based on a time point of reception of the LP-WUS by the terminal device 120 during the time period.

In some embodiments, the first information may configure the terminal device 120 to start or restart the OnDuration timer at a time point based on receiving the LP-WUS from the network device 110. In some embodiments, the first information may configure the terminal device 120 to run the OnDuration timer only for a remaining time period of the OnDuration after reception of the LP-WUS by the terminal device 120 from the network device 110.

In some embodiments, the first information may configure the terminal device 120 to run the OnDuration timer for a period of an OnDuration value regardless of at which time point the LP-WUS is received by the terminal device 120. In some embodiments, the LP-WUS may be not configured or may be not transmitted outside of the OnDuration.

In some embodiments, the time period may be the On-duration of the DRX configuration. In some embodiments, the first information may configure the terminal device 120 to start the inactivity timer upon reception of the LP-WUS by the terminal device 120.

In some embodiments, the first information may configure the terminal device 120 to start the inactivity timer upon reception of the UL grant or the DL assignment by the terminal device 120, after reception of the LP-WUS by the terminal device 120 in the On-duration.

In some embodiments, the network device 110 may transmit, to the terminal device 120, second information on a timer associated with the monitoring of the PDCCH. The second information may configure the terminal device 120 to switch from monitoring the PDCCH to monitoring the LP-WUS when the timer expires. In some embodiments, the second information may configure the terminal device 120 to start the timer after the terminal device 120 starts to use Long DRX cycle. In some embodiments, the second information may configure the terminal device 120 to start or restart the timer after a PDCCH reception by the terminal device 120. Alternatively or additionally, the second information may configure the terminal device 120 to start or restart the timer after an uplink transmission by the terminal device 120.

In some embodiments, the network device 110 may transmit, to the terminal device 120, third information configuring the terminal device 120 to switch to monitoring the LP-WUS when a long DRX is to be started or receiving a long DRX command media access control (MAC) control element (CE) from the network device 110. In some embodiments, the LP-WUS may be associated to each OnDuration for each DRX cycle of the DRX configuration. In some embodiments, the network device 110 may transmit, to the terminal device 120, fourth information configuring the terminal device 120 to switch from monitoring the PDCCH to monitoring the LP-WUS when an active time ends.

In some embodiments, an apparatus capable of performing the method 300 (for example, the terminal device 120) may comprise means for performing the respective steps of the method 300. The means may be implemented in any suitable form. For example, the means may be implemented in a circuitry or software module.

In some example embodiments, the apparatus comprises: means for obtaining, from a network device, a discontinuous reception (DRX) configuration for the apparatus; and means for monitoring a low power wake-up signal (LP-WUS) from the network device during a time period. In some example embodiments, an OnDuration timer of the DRX configuration is started based on a time point of reception of the LP-WUS during the time period. Alternatively or additionally, an inactivity timer of the DRX configuration is started based on a time point of reception of the LP-WUS during the time period.

In some embodiments, the OnDuration timer may be started or restarted at a time point based on receiving the LP-WUS from the network device 110.

In some embodiments, upon reception of the LP-WUS waking up for monitoring a physical downlink control channel (PDCCH) from a network device 110, the OnDuration timer may run only for a remaining time period of the OnDuration after reception of the LP-WUS from the network device 110.

In some embodiments, the OnDuration timer may run for a period of an OnDuration value regardless of at which time point the LP-WUS is received. In some embodiments, the LP-WUS may be not configured or may be not monitored outside of the OnDuration. In some embodiments, the time period may be the On-duration of the DRX configuration.

In some embodiments, the apparatus may further comprise means for starting the inactivity timer upon reception of the LP-WUS. In some embodiments, the apparatus may further comprise means for waking up to monitor the PDCCH until receiving an UL grant or DL assignment from the network device 110 upon reception of the LP-WUS; and means for starting the inactivity timer based on receiving the UL grant or the DL assignment.

In some embodiments, the apparatus may further comprise means for switching from monitoring the PDCCH to monitoring the LP-WUS when a timer associated with the monitoring of the PDCCH expires. In some embodiments, the timer may be started after the terminal device starts to use a long DRX cycle. In some embodiments, the timer may be started or restarted after a PDCCH reception. Alternatively or additionally, the timer may be started or restarted after an uplink transmission.

In some embodiments, the apparatus may further comprise means for switching to monitoring the LP-WUS based on determining that a long DRX is to be started or receiving a long DRX command media access control (MAC) control element (CE) from the network device 110.

In some embodiments, the LP-WUS may be associated to each OnDuration for each DRX cycle of the DRX configuration. In some embodiments, the apparatus may further comprise means for switching from monitoring the PDCCH to monitoring the LP-WUS based on determining that an active time ends.

In some embodiments, the apparatus may further comprise means for receiving the first information 204 indicating the time period from the network device 110. Alternatively or additionally, the apparatus may further comprise means for receiving, from the network device 110, second information on a timer associated with the monitoring of the PDCCH. Alternatively or additionally, the apparatus may further comprise means for receiving, from the network device 110, third information configuring the terminal device 120 to switch to monitoring the LP-WUS when a long DRX is to be started or receiving a long DRX command MAC CE from the network device 110. Alternatively or additionally, the apparatus may further comprise means for receiving, from the network device 110, fourth information configuring the terminal device 120 to switch from monitoring the PDCCH to monitoring the LP-WUS when an active time ends.

In some embodiments, the apparatus further comprises means for performing other steps in some embodiments of the method 300. In some embodiments, the means comprises at least one processor and at least one memory including computer program code, the at least one memory and computer program code configured to, with the at least one processor, cause the performance of the apparatus.

In some embodiments, an apparatus capable of performing the method 400 (for example, the network device 110) may comprise means for performing the respective steps of the method 400. The means may be implemented in any suitable form. For example, the means may be implemented in a circuitry or software module.

In some example embodiments, the apparatus comprises: means for transmitting, to a terminal device, a discontinuous reception (DRX) configuration for the terminal device; and means for transmitting, to the terminal device, first information indicating a time period, the first information configuring the terminal device to monitor a low power wake-up signal (LP-WUS) from the network device during the time period. In some embodiments, an OnDuration timer of the DRX configuration is started based on a time point of reception of the LP-WUS by the terminal device during the time period. Alternatively or additionally, an inactivity timer of the DRX configuration is started based on a time point of reception of the LP-WUS by the terminal device during the time period.

In some embodiments, the first information may configure the terminal device to start or restart the OnDuration timer at a time point based on receiving the LP-WUS from the network device.

In some embodiments, the first information may configure the terminal device to run the OnDuration timer only for a remaining time period of the OnDuration after reception of the LP-WUS by the terminal device from the network device.

In some embodiments, the first information may configure the terminal device to run the OnDuration timer for a period of an OnDuration value regardless of at which time point the LP-WUS is received by the terminal device.

In some embodiments, the LP-WUS may be not configured or may be not transmitted outside of the OnDuration. In some embodiments, the time period may be the On-duration of the DRX configuration. In some embodiments, the first information may configure the terminal device to start the inactivity timer upon reception of the LP-WUS by the terminal device.

In some embodiments, the first information may configure the terminal device to start the inactivity timer upon reception of the UL grant or the DL assignment by the terminal device, after reception of the LP-WUS by the terminal device in the On-duration.

In some embodiments, the apparatus may further comprise: means for transmitting, to the terminal device, second information on a timer associated with the monitoring of the PDCCH. The second information may configure the terminal device to switch from monitoring the PDCCH to monitoring the LP-WUS when the timer expires. In some embodiments, the second information may configure the terminal device to start the timer after the terminal device starts to use Long DRX cycle. In some embodiments, the second information may configure the terminal device to start or restart the timer after a PDCCH reception by the terminal device. Alternatively or additionally, the second information may configure the terminal device to start or restart the timer after an uplink transmission by the terminal device.

In some embodiments, the apparatus may further comprise: means for transmitting, to the terminal device, third information configuring the terminal device to switch to monitoring the LP-WUS when a long DRX is to be started or receiving a long DRX command media access control (MAC) control element (CE) from the network device.

In some embodiments, the LP-WUS may be associated to each OnDuration for each DRX cycle of the DRX configuration. In some embodiments, the apparatus may further comprise: means for transmitting, to the terminal device, fourth information configuring the terminal device to switch from monitoring the PDCCH to monitoring the LP-WUS when an active time ends.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

FIG. 5 illustrates a simplified block diagram of a device 500 that is suitable for implementing some example embodiments of the present disclosure. The device 500 may be provided to implement a communication device, for example, the network device 110 or the terminal device 120 as shown in FIG. 1A. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIG. 2. The embodiments of the present disclosure may also be implemented by hardware or by a combination of software and hardware.

In some example embodiments, the program 530 may be tangibly contained in a computer-readable medium which may be included in the device 500 (such as in the memory 520) or other storage devices that are accessible by the device 500. The device 500 may load the program 530 from the computer-readable medium to the RAM 522 for execution. The computer-readable medium may include any types of tangible non-volatile storage, such as ROM, EPROM, a flash memory, a hard disk, CD, DVD, and the like.

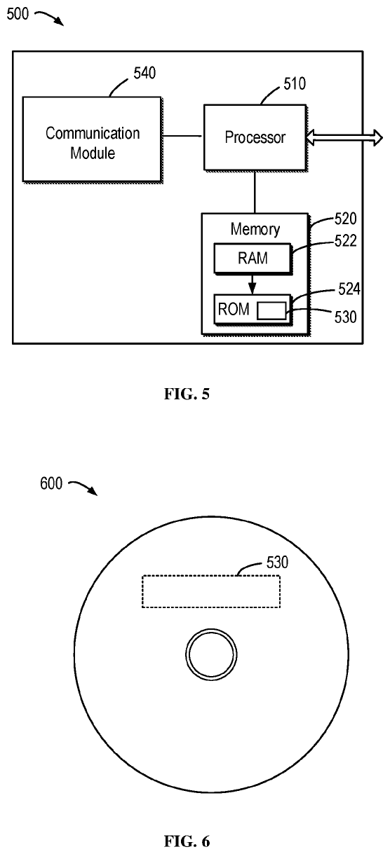

FIG. 6 illustrates a block diagram of an example of a computer-readable medium 1000 in accordance with some example embodiments of the present disclosure. The computer-readable medium 600 has the program 530 stored thereon. It is noted that although the computer-readable medium 600 is depicted in form of CD or DVD in FIG. 6, the computer-readable medium 600 may be in any other form suitable for carry or hold the program 530.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 300 or 400 as described above with reference to FIG. 3 or 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

### LIST OF ABBREVIATIONS

LP-WUS Low Power Wake-Up Signal
MAC Medium Access Control
DRX Discontinuous Reception
TAT Timing Alignment Timer
WuR Wake-up Receiver
eDRX extended Discontinuous Reception
IoT Internet of Things
PDCCH Physical Downlink Control CHannel
PDSCH Physical Downlink Shared CHannel
DCI Downlink Control Information
RRC Radio Resource Control

1-37. (canceled)

38. An apparatus comprising:
at least one processor; and
at least one memory storing instructions that, when executed by the at least one processor, cause the apparatus at least to:
obtain, from a network device, a discontinuous reception (DRX) configuration for the apparatus; and
monitor a low power wake-up signal (LP-WUS) from the network device during a time period, wherein at least one of an OnDuration timer or an inactivity timer of the DRX configuration is started based on a time point of reception of the LP-WUS during the time period.

39. The apparatus of claim 38, wherein the time period is associated with an On-duration of the DRX configuration.

40. The apparatus of claim 38, wherein the OnDuration timer is started or restarted at a time point based on receiving the LP-WUS from the network device.

41. The apparatus of claim 38, wherein upon reception of the LP-WUS waking up for monitoring a physical downlink control channel (PDCCH) from the network device, the OnDuration timer runs only for a remaining time period of the OnDuration after reception of the LP-WUS from the network device.

42. The apparatus of claim 38, wherein the OnDuration timer runs for a period of an OnDuration value regardless of at which time point the LP-WUS is received.

43. The apparatus of claim 38, wherein the LP-WUS is not configured or is not monitored outside of the OnDuration.

44. The apparatus of claim 38, wherein the time period is the On-duration of the DRX configuration.

45. The apparatus of claim 44, wherein the apparatus is further caused to:
upon reception of the LP-WUS, start the inactivity timer.

46. The apparatus of claim 38, wherein the apparatus is further caused to:
upon reception of the LP-WUS, wake up to monitor the PDCCH until receiving an UL grant or DL assignment from the network device; and
based on receiving the UL grant or the DL assignment, start the inactivity timer.

47. The apparatus of claim 38, wherein the apparatus is further caused to:
switch from monitoring the PDCCH to monitoring the LP-WUS when a timer associated with the monitoring of the PDCCH expires.

48. The apparatus of claim 47, wherein the timer is started after the apparatus starts to use a long DRX cycle.

49. The apparatus of claim 47, wherein the timer is started or restarted after at least one of a PDCCH reception or an uplink transmission.

50. The apparatus of claim 38, wherein the apparatus is further caused to:
based on determining that a long DRX is to be started or receiving a long DRX command medium access control (MAC) control element (CE) from the network device, switch to monitoring the LP-WUS.

51. The apparatus of claim 38, wherein the LP-WUS is associated to each OnDuration for each DRX cycle of the DRX configuration.

52. The apparatus of claim 38, wherein the apparatus is further caused to:
based on determining that an active time ends, switch from monitoring the PDCCH to monitoring the LP-WUS.

53. The apparatus of claim 38, wherein the apparatus is further caused to receive, from the network device, at least one of:
first information indicating the time period;
second information on a timer associated with the monitoring of the PDCCH;
third information configuring the apparatus to switch to monitoring the LP-WUS when a long DRX is to be started or receiving a long DRX command MAC CE from the network device; or
fourth information configuring the apparatus to switch from monitoring the PDCCH to monitoring the LP-WUS when an active time ends.

54. An apparatus comprising:
at least one processor; and
at least one memory storing instructions that, when executed by the at least one processor, cause the apparatus at least to:
transmit, to a terminal device, a discontinuous reception (DRX) configuration for the terminal device; and
transmit, to the terminal device, first information indicating a time period, the first information configuring the terminal device to monitor a low power wake-up signal (LP-WUS) from the apparatus during the time period, wherein at least one of an OnDuration timer or an inactivity timer of the DRX configuration is started based on a time point of reception of the LP-WUS by the terminal device during the time period.

55. The apparatus of claim 54, wherein the time period is associated with an On-duration of the DRX configuration.

56. The apparatus of claim 54, wherein the first information configures the terminal device to start or restart the OnDuration timer at a time point based on receiving the LP-WUS from the apparatus.

57. A method comprising:
obtaining, at a terminal device and from a network device, a discontinuous reception (DRX) configuration for the terminal device; and
monitoring, by the terminal device, a low power wake-up signal (LP-WUS) from the network device during a time period, wherein at least one of an OnDuration timer or an inactivity timer of the DRX configuration is started based on a time point of reception of the LP-WUS during the time period.
